(19) United States
(12) Patent Application Publication
(10) Pub. No.: US 2013/0092090 A1
(43) Pub. Date: Apr. 18, 2013

(54) PET WATERING SYSTEM FOR CAGE, CRATE, OR KENNEL

(71) Applicant: Scott D. McCallum, Reno, NV (US)

(72) Inventor: Scott D. McCallum, Reno, NV (US)

(21) Appl. No.: 13/612,560

(22) Filed: Sep. 12, 2012

Related U.S. Application Data
(60) Provisional application No. 61/533,618, filed on Sep. 12, 2011.

(51) Int. Cl. A01K 7/06

(52) U.S. Cl. CPC A01K 7/06
USPC 119/74; 119/78

(57) ABSTRACT

This application discloses example embodiments of methods, apparatus, and systems related to animal watering systems having a mechanism for circulating and/or filtering water. For example, one exemplary embodiment disclosed herein comprises a main body portion comprising a water storage chamber and a water filtering and circulating chamber, the water storage chamber being fluidly coupled with the water filtering and circulating chamber via a valve between the water storage chamber and the water filtering and circulating chamber; a water tray selectively attachable to the main body portion, the main body portion and the water tray being fluidly coupled to one another when the water tray is attached to the main body portion; a water filtration system in the water filtering and circulating chamber; and a water circulating system that is configured to automatically deactivate when the water in the watering system is insufficient to circulate using the water circulating system.

### CROSS REFERENCE TO RELATED APPLICATION

This application claims the benefit of U.S. Provisional Patent Application No. 61/533,618, filed Sep. 12, 2011, which is incorporated herein by reference in its entirety.

### FIELD

This application relates to water containers for animals. In particular, this application relates to watering systems that can be removably attached to a cage, crate, or kennel and that have a mechanism for circulating and/or filtering water.

### SUMMARY

Disclosed below are representative embodiments of methods, apparatus, and systems related to watering systems for animals that have a mechanism for circulating and/or filtering water. The disclosed methods, apparatus, and systems should not be construed as limiting in any way. Instead, the present disclosure is directed toward all novel and nonobvious features and aspects of the various disclosed embodiments, alone and in various combinations and subcombinations with one another. Furthermore, any features or aspects of the disclosed embodiments can be used alone or in various combinations and subcombinations with one another. The disclosed methods, apparatus, and systems are not limited to any specific aspect or feature or combination thereof, nor do the disclosed embodiments require that any one or more specific advantages be present or problems be solved. Furthermore, as used herein, the term “and/or” means any one item or combination of items in the phrase.

One exemplary embodiment disclosed herein is a watering system for attachment to an animal cage, kennel, or crate comprising: a main body portion comprising a water storage chamber and a water filtering and circulating chamber, the water storage chamber being fluidly coupled with the water filtering and circulating chamber via a valve between the water storage chamber and the water filtering and circulating chamber; a water tray, the water tray being removably attachable to the main body portion, the main body portion and the water tray being fluidly coupled to one another when the water tray is attached to the main body portion; a water filtration system in the water filtering and circulating chamber; and a water circulating system, wherein the water circulating system is configured to automatically deactivate when the water in the watering system is insufficient to circulate using the water circulating system.

Another exemplary embodiment disclosed herein is a watering system configured for attachment to an animal cage, kennel, or crate comprising a water circulating system, the water circulating system being configured to automatically deactivate when the water in the watering system is insufficient to circulate using the water circulating system.

A further exemplary embodiment disclosed herein is a watering system configured for attachment to an animal cage, kennel, or crate comprising a water filtration system that comprises one or more ion-exchange resin elements.

Yet a further embodiment disclosed herein is a watering system configured for attachment to an animal cage, kennel, or crate comprising: a main body portion comprising a water storage chamber and a water filtering and circulating chamber, the water storage chamber being fluidly coupled with the water filtering and circulating chamber via a valve between the water storage chamber and the water filtering and circulating chamber; and a water tray, the water tray being selectively attachable to the main body portion via two or more fluid conduits, the main body portion and the water tray being fluidly coupled to one another when the water tray is attached to the main body portion via the two or more fluid conduits.

The foregoing and other embodiments, objects, features, and advantages of the disclosed technology will become more apparent from the following detailed description, which proceeds with reference to the accompanying figures.

### BRIEF DESCRIPTION OF THE DRAWINGS

FIG. 1 is a perspective view of the front and left sides of an exemplary embodiment of a watering system designed according to the disclosed technology.

FIG. 2 is a perspective view of the back and left sides of the exemplary embodiment of the watering system of FIG. 1.

FIG. 3 is a top perspective view of the front side of the exemplary embodiment of the watering system of FIG. 1

FIG. 4 is a top perspective view of the back side of the exemplary embodiment of the watering system of FIG. 1.

FIG. 5 is a top view of the exemplary embodiment of the watering system of FIG. 1

FIG. 6 is a top perspective of the back side of the main body of the watering system of FIG. 1 with the water storage chamber removed and showing an interior of the water filtering and circulating chamber.

FIG. 7 is a perspective view of the removable filter removed from the water filtering and circulating chamber of FIG. 6.

FIG. 8 is a perspective view of the interior of the post-filtering compartment of the water filtering and circulating chamber of FIG. 6.

FIG. 9 is a perspective view of a pump suitable for use in the post-filtering compartment of the water filtering and circulating chamber of FIG. 6.

FIG. 10 is a top view of the interior of the post-filtering compartment of the water filtering and circulating chamber of FIG. 6 with the pump in its operating position.

FIG. 11 is a schematic block diagram of a pump circuit as can be used in the exemplary watering system of FIG. 1.

FIG. 12 is a flow chart illustrating an exemplary process of operating the pump of the watering system of FIG. 1.

FIG. 13 is a perspective view showing the back of the exemplary water storage chamber of FIG. 1 and its associated valve.

FIG. 14 is a top view of the water storage chamber of FIG. 1 and its associated valve.

FIG. 15 is a zoomed-in view of the valve of FIG. 13 in an open position.

FIG. 16 is a zoomed-in view of the valve of FIG. 13 in a closed position.

FIG. 17 is a right side view of the exemplary watering system of FIG. 1.

FIG. 18 is a left side view of the exemplary watering system of FIG. 1.

FIG. 19 is a back view of the exemplary watering system of FIG. 1.

FIG. 20 is a front view of the exemplary watering system of FIG. 1.

FIG. 21 is a bottom view of the exemplary watering system of FIG. 1.

FIG. 22 is a perspective view of an exemplary AC/DC converter suitable for use with the exemplary watering system of FIG. 1.

FIG. 23 is a front-side perspective view of a further embodiment of the watering system 100 that includes a food tray coupled to the water tray.

FIG. 24 is a perspective view of the watering system of FIG. 1 in operation.

### DETAILED DESCRIPTION

Disclosed below are representative embodiments of methods, apparatus, and systems related to watering systems for animals that have a mechanism for circulating and/or filtering water. The disclosed methods, apparatus, and systems should not be construed as limiting in any way. Instead, the present disclosure is directed toward all novel and nonobvious features and aspects of the various disclosed embodiments, alone and in various combinations and subcombinations with one another. Furthermore, any features or aspects of the disclosed embodiments can be used alone or in various combinations and subcombinations with one another. The disclosed methods, apparatus, and systems are not limited to any specific aspect or feature or combination thereof, nor do the disclosed embodiments require that any one or more specific advantages be present or problems be solved. Furthermore, as used herein, the term “and/or” means any one item or combination of items in the phrase.

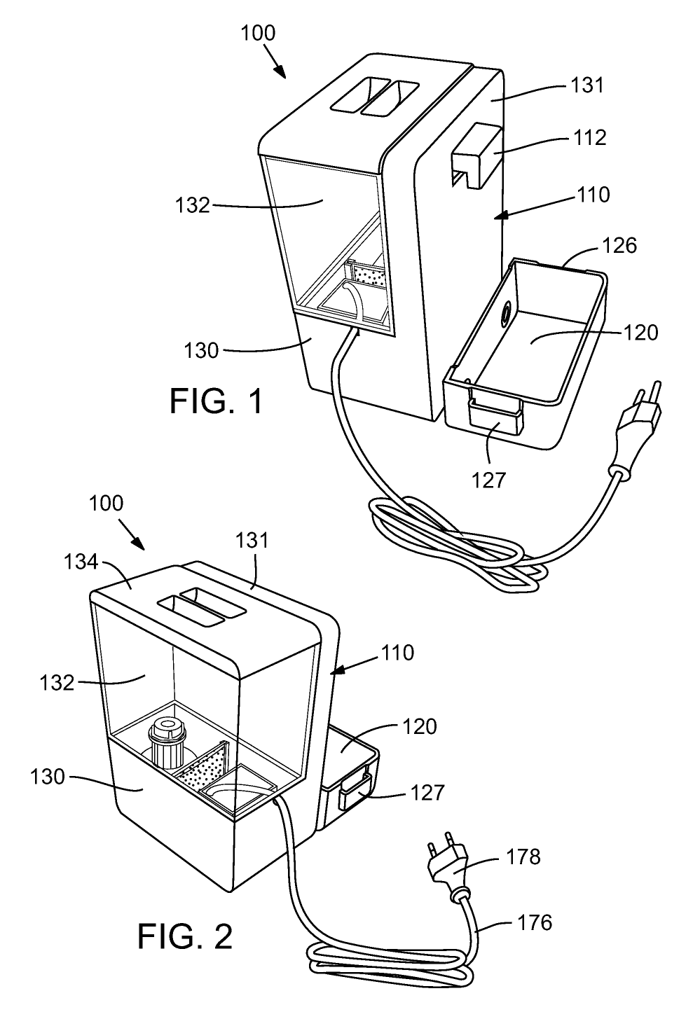

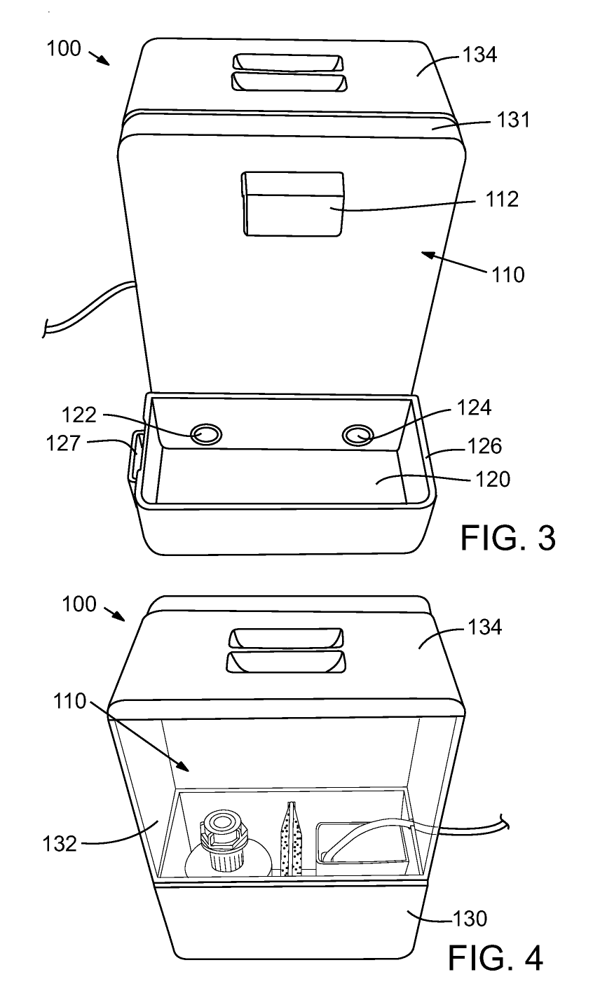

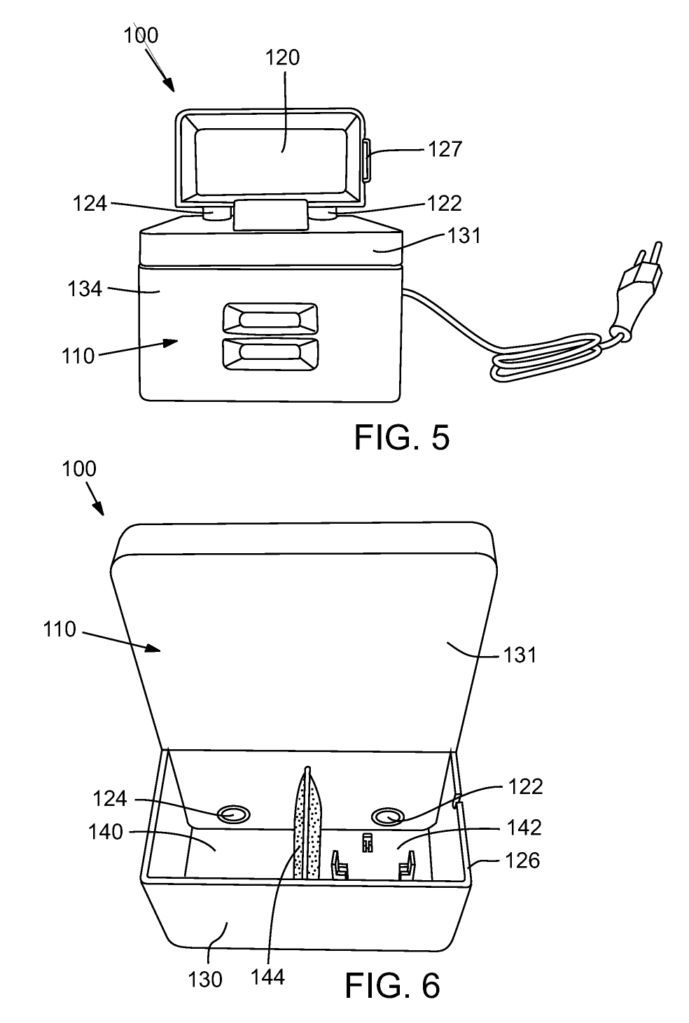

FIGS. 1-4 are various views of an exemplary embodiment of an animal watering system 100 designed according to the disclosed technology. In particular, FIG. 1 is a perspective view of the front of an exemplary embodiment of a watering system 100 designed according to the disclosed technology. FIG. 2 is a perspective view of the back of the exemplary embodiment of the watering system 100. FIG. 3 is a top perspective view of the front of the exemplary embodiment of the watering system 100. FIG. 4 is a top perspective view of the back of the exemplary embodiment of the watering system 100. FIG. 5 is top view of the exemplary embodiment of the watering system.

As shown in FIGS. 1-5, the watering system 100 comprises a main body 110 and a water tray 120. The main body 110 comprises a water filtering and circulating chamber 130 and a removable water storage chamber 132. In the illustrated embodiment, the water storage chamber 132 is separated from the water filtering and circulating chamber 130 and is located above the water filtering and circulating chamber 130. Furthermore, and as more fully explained below, the water storage chamber 132 is associated with a valve mechanism that regulates the water level in the water filtering and circulating chamber 130 and the water tray 120.

The water tray 120 is fluidly coupled to the water filtering and circulating chamber 130. In the illustrated embodiment, for example, a first fluid conduit 122 and a second fluid conduit 124 extend between the main body 110 and the water tray 120 and fluidly couple the water tray 120 to the water filtering and circulating chamber 130. The first fluid conduit 122 and the second fluid conduit 124 can be integrally formed into either the water tray 120 or the main body 110. In the illustrated embodiment, the first fluid conduit 122 and the second fluid conduit 124 are integrally formed into the water tray 120. Furthermore, the first fluid conduit 122 and the second fluid conduit 124 are configured to be removably engaged to corresponding apertures on the main body 110 (e.g., via a friction fit, snap-fit mechanism, releasable collar mechanism, or other such mechanism). In other words, the water tray 120 (together with the first fluid conduit 122 and the second fluid conduit 124) can be separated from the main body 110, thus allowing the water tray 120 to be placed inside of a animal kennel, crate, or cage while the main body 110 is placed on the outside of an animal kennel, crate, or cage. The main body 110 and the water tray 120 can then be re-attached to one another at the first fluid conduit 122 and the second fluid conduit 124. One or more rubber washers (not shown) can be enclosed or included in the corresponding apertures on the main body 110 in order to create a tighter seal between the main body 110 and the water tray 120.

In general, the water tray 120 can have a variety of shapes and depths, depending on the intended use and animal for the watering system 100. In the illustrated embodiment, the water tray 120 is designed for smaller animals (e.g., cats, rabbits, hamsters, and the like), and has a generally rectangular shape with a depth of 2 cm to 10 cm. When water is circulating in the water tray 120, the water level is less than a top rim 126 of the water tray 120 (e.g., by 0.5 cm or more). For example, FIG. 24 is an image of the watering system 100 in operation with the water level in the water tray being at about 1 cm below the rim of the water tray 120.

Furthermore, the water tray 120 is attached to the main body 110 at a lower region of the main body 110. This allows the water tray 120 to be placed at a comfortable drinking level for the animal in the cage, crate, or kennel and allows the larger main body 110 to engage the cage, crate, or kennel at other points on the body of the cage, crate, or kennel door or wall. For example, the main body 110 includes a hook member 112 (e.g., an L-shaped hook member) that protrudes from a top region of the front face of a main body central member 131. The hook member 112 is configured to engage a portion of the cage, crate, or kennel door or wall so that the main body 110 hangs (or is otherwise secured in place) to the cage, crate, or kennel door or wall. In the illustrated embodiment, the hook member 112 is integrally formed into the main body 110 but can be a separate member that is attachable to the main body. Further, the hook member 112 can include an adjustment mechanism that allows the hook member to be extended further outwardly, upwardly, downwardly, or laterally (e.g., via one or more telescoping parts of the hook member that can be locked and/or unlocked into a variety of positions), thus allowing the main body 110 to be removably secured to a variety of cages, crates, or kennels and at a variety of locations on the cages, crates, or kennels.

In the illustrated embodiment, the water tray 120 additionally includes a protrusion 127 that allows the water tray 120 to be coupled to other apparatus. The protrusion 127 also serves as a handle that allows a user to more easily separate the water tray 120 from the main body 110 and empty and clean the water tray 120 as desired.

The main body 110 of the watering system 100 can also have a variety of shapes and sizes depending on the intended use and animal for the watering system 100. In the illustrated embodiment, the main body 110 has a generally rectangular cross-section and is configured for attachment to a kennel or cage for smaller animals (e.g., cats, rabbits, hamsters, and the like). Further, in the illustrated embodiment, the water filtering and circulating chamber 130 is integrally formed with a main body central member 131 and has an open top side, while the water storage chamber 132 comprises a water container that is separable from the water filtering and circulating chamber 130 and the main body member 131. The illustrated water storage chamber 132 has side walls, a bottom surface, and an open top side covered by a removable lid 134 that is configured to engage an upper lip of the side walls of the water storage chamber 132, thereby enclosing the interior of the water storage chamber 132. The removable lid 134 allows the water storage chamber 132 to be easily filled from the top of the chamber. In the illustrated embodiment, the water storage chamber 132 is formed of a translucent plastic while the water filtering and circulating chamber 130, the main body central member 131, and the removable lid 134 are formed from an opaque plastic (e.g., acrylonitrile butadiene styrene (“ABS”) or other thermoplastic). In other embodiments, any of the water storage chamber 132, the water filtering and circulating chamber 130, the main body central member 131, and/or the removable lid 134 can be opaque or translucent.

FIG. 6 is a top perspective of the main body 110 with the water storage chamber 132 removed and showing an interior of the water filtering and circulating chamber 130. As seen in FIG. 6, the water filtering and circulating chamber 130 comprises a pre-filtering compartment 140 and a post-filtering compartment 142. A removable filter 144 forms the partition between the compartments 140, 142, and is received within sleeves 146, 148 of the water filtering and circulating chamber 130 (visible in FIGS. 8 and 10).

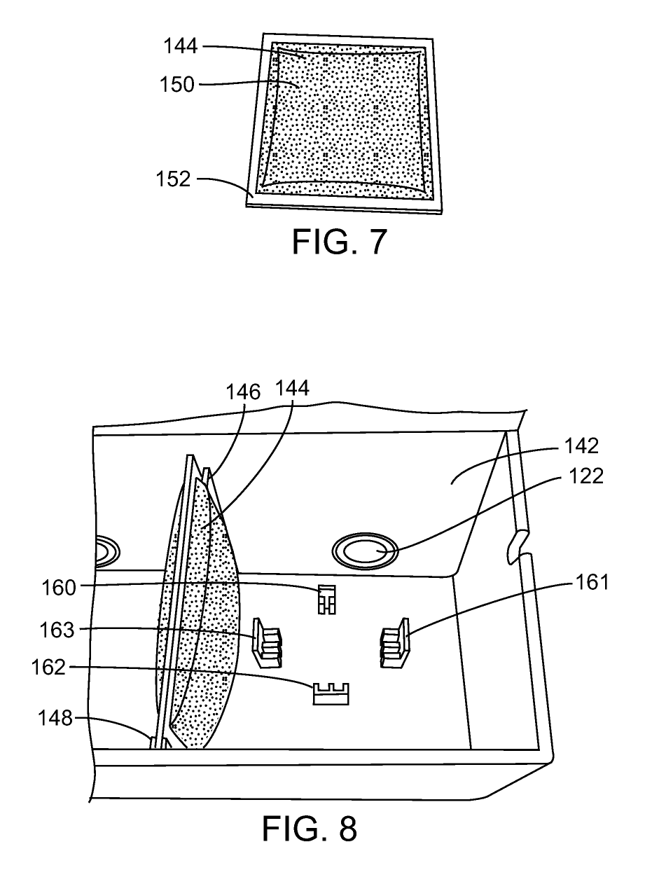

FIG. 7 shows the removable filter 144 removed from the water filtering and circulating chamber 130. The removable filter 144 comprises a rectangular- or square-shaped filter bag 150 whose edges are attached to a plastic frame 152 that is sized to be received within the sleeves 146, 148. The filter bag 150 can be formed from a suitably porous material and can enclose one or more filtration components. For example, in particular embodiments, the filter bag 150 encloses ion exchange resin (e.g., beads of ion exchange resin). The ion exchange resin serves to remove undesirable ions from the water (e.g., poisonous and heavy metal ions) and exchanges them with more harmless ions. The filter bag can include one or more additional filter components. For instance, in particular embodiments, granulated activated carbon or charcoal is also or alternatively included within the filter bag 150. The granulated activated carbon serves to reduce other water impurities, such as chlorine, pesticides, and/or organic contaminants. When the filter bag 150 is no longer effective in filtering water, the filter bag 150 and plastic frame 152 can be removed from the water filtering and circulating chamber 130 and replaced. Additional filtration components can also be part of the filtration system and used in the water filtering and circulating chamber 130. For example, a pre-filter component (e.g., a sponge, mesh, or screen having apertures of a predetermined size) can be placed in front of or after the filter bag 150 or incorporated into the plastic frame 152 and used to filter larger particles (e.g., particles with a diameter of 4 mm or larger, 5 mm or larger, or other diameters). Additionally, a UV-light filtration mechanism can be placed in front of or after the filter bag 150.

FIG. 8 is a zoomed-in top perspective view of the post-filtering compartment 142 and shows pump positioning members 160, 161, 162, 163 (sometimes referred to as “holds” or “guides”). In the illustrated embodiment, the pump positioning members 160, 161, 162, 163 are integrally formed into the post-filtering compartment 142 and are configured to support and position a pump (e.g., pump 170) in a desired orientation when the pump is seated in the post-filtering compartment.

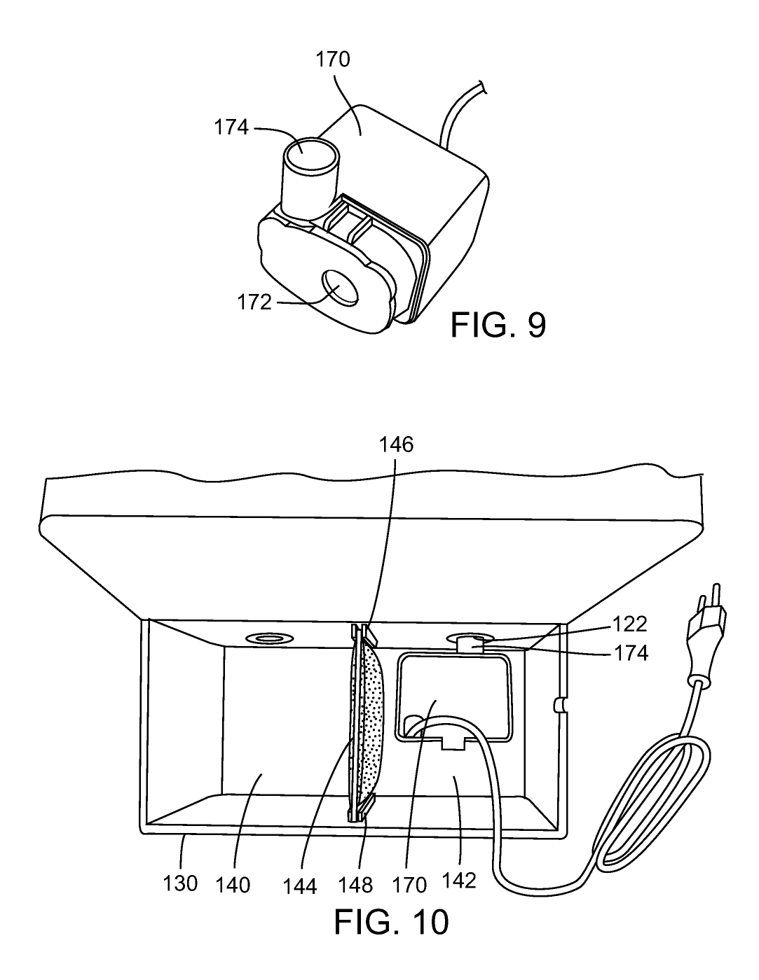

FIG. 9 is a perspective view of pump 170 removed from the post-filtering compartment 142. Pump 170 comprises an input port 172 that is located adjacent to an impeller (not visible) of the pump. In use, the impeller of the pump 170 operates to force water through the input port 172 and out the output port 174.

Returning to FIG. 8, the pump positioning members 160, 161, 162, 163 are configured to orient the pump 170 so that the output port 174 engages and is fluidly coupled to the first fluid conduit 122. This orientation is shown in FIG. 10, which is a top view of the post-filtering compartment 142 showing the output port 174 of the pump 170 fluidly coupled to the first fluid conduit 122.

In operation, the pump 170 pumps water from the post-filtering compartment 142 through the first fluid conduit 122 and into the water tray 120. Further, on account of the continuous operation of the pump, water in the water tray 120 is urged through the second fluid conduit 124, into the pre-filtering compartment 140, through the filter bag 150, and back into the post-filtering compartment 142, where the process is repeated. In this way, the water in the water tray 120 is constantly circulated and filtered.

The pump positioning member 160, 161, 162, 163 further include ledges (or platforms) that serve to orient the input port 172 of the pump 170 downward toward the bottom surface of the post-filtering compartment 142 and to suspend the input port 172 slightly above (e.g., 1-50 mm above) the bottom surface of the post-filtering compartment 142. In this orientation, the pump 170 can draw water to a lower level than if the input port 172 were located on a side of the pump. Furthermore, because the input port 172 of the pump 170 is only slightly above the bottom surface of the post-filtering compartment 142, the pump 170 can effectively pump all or substantially all (e.g., all except for 1-50 mL) of the water from the water filtering and circulating chamber 130.

In particular embodiments, the pump 170 includes a shut-off mechanism that automatically stops the pump 170 and the impeller when the pump 170 is not pumping water. For example, when the water level in the water filtering and circulating chamber 130 falls beneath the input port 172, water will no longer be pumped through the pump 170. Running the pump 170 when no water is at the input port 712 can cause the pump 170 to overheat and potentially fail (e.g., because, without water, the impeller and impeller motor operate with a much higher speed). In certain embodiments, the pump 170 includes a sensor, switch, and associated circuitry configured to detect a speed at which the pump 170 is operating and to switch the pump off when the pump speed (e.g., the RPMs of the impeller or impeller rotor) exceeds a threshold rate. The threshold rate can be set so that it is exceeded when the pump 170 operates in the absence of water at its input port 172 and so that it is not exceeded when the pump 170 operates with water at its input port 172.

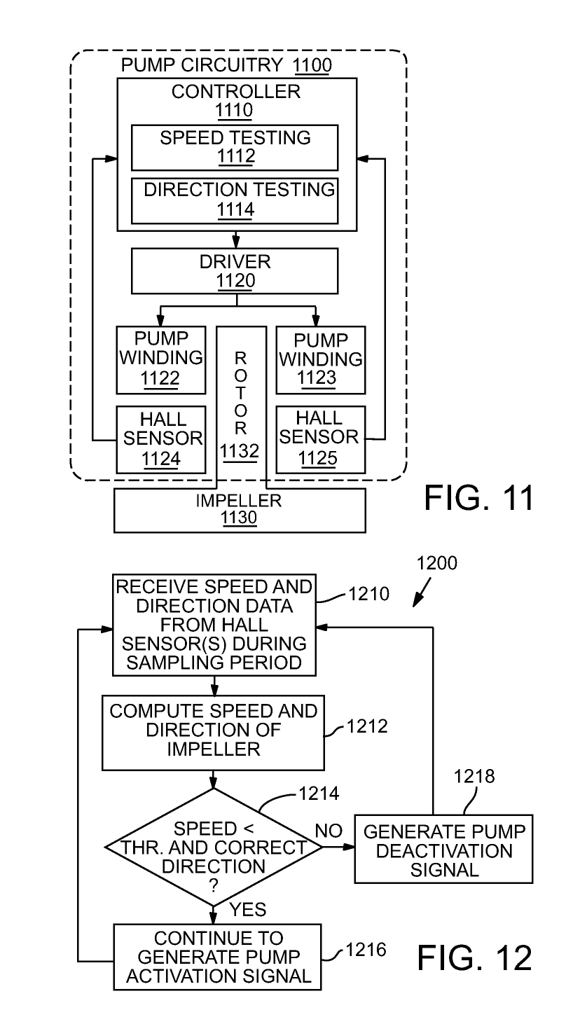

FIG. 11 is a schematic block diagram of a suitable pump circuit 1100. The pump circuit 1100 comprises one or more sensors (e.g., hall-effect sensors 1124, 1125) configured to generate a signal as the permanent magnets associated with an impeller rotor 1132 pass in proximity to the sensors. The hall-effect sensors can be positioned relative to one another so that the signals they generate can be decoded to determine not only the speed at which the impeller rotor 1132 is rotating but also the direction of rotation (e.g., the hall-effect sensors can be positioned so that they are not symmetrical with one another). The pump circuit 1100 further comprises a controller 1110, which can be a microprocessor-based or microcontroller-based controller. In other embodiments, the controller 1110 comprises other suitable electrical and/or logic components. The controller 1110 can be configured to receive the signals from the one or more hall sensors (comprising speed and direction data) and determine the speed of the impeller rotor 1132 using a speed testing process 1112 and the direction of the rotor using a direction testing process 1114. Based on this information, the controller 1110 can evaluate whether the impeller rotor 1132 and impeller 1130 are operating at an expected speed and direction (e.g., consistent with the presence of water at the input port 172) or at an unexpected speed and direction (e.g., consistent with the absence of water at the input port 172). As a result of this evaluation, the controller 1110 can generate a control signal for a driver 1120 to either continue to drive electrical current through the pump windings (e.g., pump windings 1122, 1123) and thereby maintain pump operation, or discontinue the current and thereby deactivate the pump 170. For instance, the pump 170 can remain activated if the speed of the impeller rotor 1132 is below a threshold value and the direction of the impeller rotor 1132 is the correct direction (e.g., the direction that causes water to be pumped from the input port 172 to the output port 174).

FIG. 12 is a flow chart illustrating an exemplary process 1200 of operating the pump 170 that can be performed by the controller 1110. At 1210, speed and direction data is received from one or more sensors (e.g., the hall-effect sensors 1124, 1125) during a sampling period. The sampling period can vary from implementations, but in one embodiment is between 1 and 120 seconds (e.g., 5-10 seconds). At 1212, the speed and direction of the impeller 1130 is determined from the received signals. For example, the speed of the impeller 1130 can be determined from the number of signals received from the respective sensors during the sampling period, and the direction of the impeller 1130 can be determined from the relative order of the signals received from the respective sensors. At 1214, a determination is made as to whether the determined speed is less than (or less than or equal to) a threshold speed and if the determined direction is a correct direction (indicating that the impeller 1130 is pumping water to the pump output port 174). If both criteria are met, then, at 1216, the controller 1110 continues to generate a pump activation signal that drives the pump 170. If one of the criteria is not met, then at 1218 the controller 1110 generates a pump deactivation signal that causes the driver 1120 to shut off the pump 170.

In certain embodiments, the process 1200 is performed only after the pump 170 has operated for a threshold period of time (e.g., 5-10 seconds). This allows water to begin circulating through the water filtering and circulating chamber 130 and the water tray 120 and allows the system to a reach a state of stable circulation before testing the whether the pump 170 should be shut off. Additionally, in some embodiments, only speed data is used to determine whether to shut off the pump 170. The direction data can be useful, however, to prevent a false reading of impeller speed in the event that the impeller 1130 is spinning in an opposite direction. Furthermore, the direction data can be useful to prevent the impeller 1130 from restarting once the impeller 1130 stops, since a stopped impeller has a speed less than the speed threshold. Because a stopped impeller will generate no (or insufficient) signals from the hall-effect sensors to detect direction, however, the direction criterion will not be satisfied by a stopped impeller.

In certain embodiments, two speed thresholds can be used to determine pump activation. In particular embodiments, for example, two speed thresholds must be satisfied in order for the pump 170 to remain activated: a first threshold that signals when the impeller speed is too high, and a second threshold that signals when the impeller speed is too low (and is consistent with the impeller 1130 being stopped). In such embodiments, the pump 170 will only continue to operate when the detected speed is between the first and the second thresholds.

The mechanisms for shutting off the pump 170 described above should not be construed as limiting, as other mechanisms can be used. For example, the watering system 100 can include a sensor that senses the depth of the water in the interior of the water filtering and circulating chamber 130 and sends a shut-off signal to the pump 170 when the depth of the water is at or beneath a threshold depth.

In the illustrated embodiment, the pump 170 is configured to operate using DC power. Further, as best seen in FIG. 2, the pump 170 is electrically coupled to a power cord 176, which is typically coupled to an AC/DC converter and plug unit (an example of which is shown as AC/DC converter and plug unit 2200 in FIG. 22). In the illustrated embodiment, however, the power cord 176 is illustrated as terminating at a plug 178. The AC/DC converter and plug unit (such as unit 2200 in FIG. 22) is configured to convert AC power (e.g., from an AC outlet having AC power at 100-240V) to DC power (e.g., to 12V of DC power). The use of DC power has several advantages that can be realized in one or more embodiments of the disclosed technology. One advantage that can be realized is that the use of DC power allows the watering system 100 to use the same DC pump for multiple international countries, making the watering system 100 more easily adapted for manufacture, sale, and use in a wide variety of countries around the world. More specifically, each country has its own power standard, which in many instances are not identical to one another. For example, North America operates using a standard of 120V at 60 Hz, Europe and many Asian countries operate using a standard of 230-240V at 50 Hz, and Japan operates using a standard of 100V at 50-60 Hz. By using a pump that operates using DC power (rather than AC power), an AC/DC converter can used to convert an input AC signal to a common 12V DC output. Depending on the country in which the water container is to be used, the plug configuration of the AC/DC converter may change, but the converter circuitry can be the same for a wide variety of different countries and AC inputs. For instance, a single converter circuit can be used to convert power from a 100-240V AC input to a common 12V DC output. By contrast, if the pump operated using AC power, then different pumps, each adapted for a different AC power source, would need to be used, or different AC transformers would need to be included on the power cord to create the proper power supply. Such a system would add expense, weight, and unnecessary complication to the manufacturing and distribution of the water container. Another advantage that can be realized in embodiments of the disclosed technology is that the use of DC power allows the watering system 100 to use a brushless DC motor in the pump. Such motors can operate more quietly, efficiently, and longer than their AC counterparts. A further advantage that can be realized is that the use of DC power allows the DC motor to receive power from other, alternative power sources. For example, the pump 170 of the watering system 100 can operate using power generated from a solar panel, which produces DC power. For example, in particular implementations, the pump can be selectively coupled to a solar panel via a switching mechanism that couples the pump to either a solar panel or an AC power outlet. The switching mechanism can include circuitry for causing the power for the DC pump to be switched from the solar panel to the AC power outlet when the DC voltage or power provided by the solar panel falls below a threshold value, and to switch back to the solar panel when the DC voltage or power provided by the solar panel exceeds the threshold value. In other embodiments, the pump 170 can be coupled to another DC power source. For instance, a cigarette lighter adapter can be used to provide DC power to the pump 170. With such an adapter, the watering system 100 can be used in mobile environments (e.g., campers, RVs, motor homes, other motor vehicles, and the like).

In other embodiments, the pump used with the watering system 100 is an AC pump and operates using AC power. In still further embodiments, the pump does not have an automatic shutoff mechanism. For example, the pump can run continuously until it is switched off or disconnected from its power source.

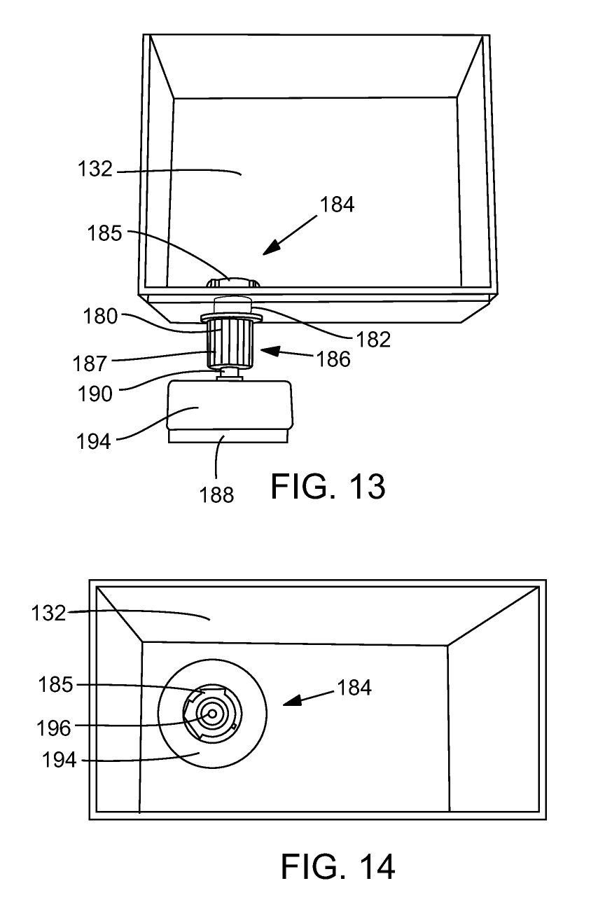

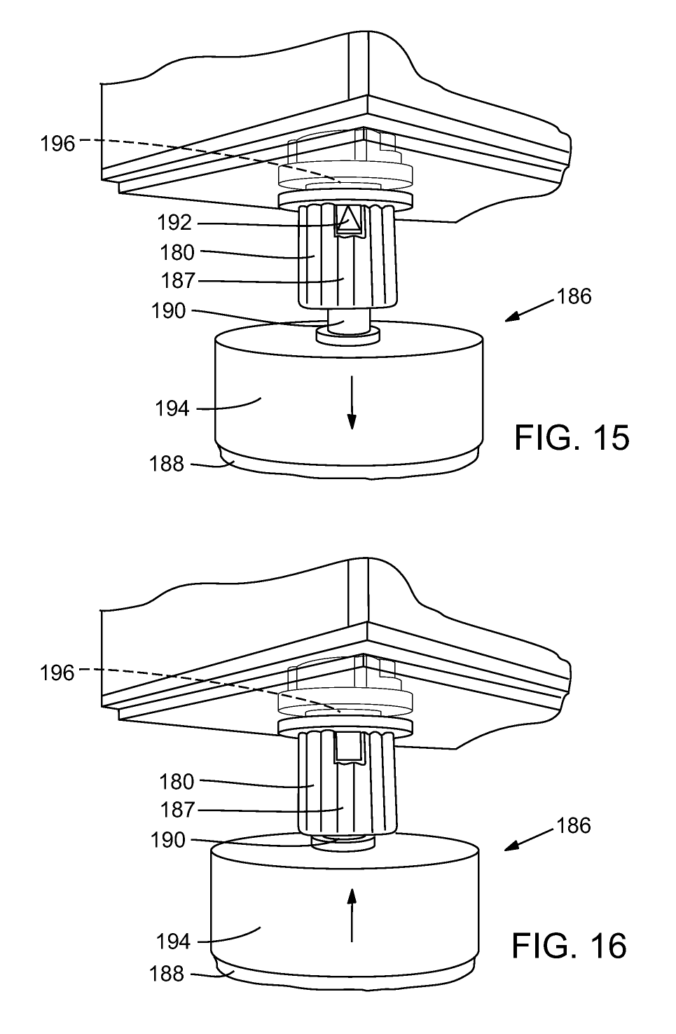

FIGS. 13-16 illustrate various aspects of the water storage chamber 132. FIG. 13 is a back view of the water storage chamber 132 and associated valve 180. FIG. 14 is a top view of the water storage chamber 132 and the valve 180. FIG. 15 is a zoomed-in view of the valve 180 in an open position, whereas FIG. 16 is a zoomed-in view of the valve 180 in a closed position.

The water storage chamber 132 can have a variety of shapes and sizes depending on the intended use and animal for the watering system 100. In the illustrated embodiment, the water storage chamber 132 has a generally rectangular cross-section. Further, in the illustrated embodiment, the water storage chamber 132 can hold about 1 liter of water. The illustrated water storage chamber 132 is formed from a transparent plastic material, but can be formed from an opaque or partially transparent material as well.

The illustrated water storage chamber 132 also includes an aperture 182 in which a portion of the valve 180 is located. In the illustrated embodiment, the valve 180 is a float-actuated (or buoyancy-activated) valve that selectively allows passage of water from the water storage chamber 132 to the filtering and circulating chamber 130 based on the depth of water in the filtering and circulating chamber 130 and the level at which a float associated with the valve floats in the water in the chamber 130. Further, because the water storage chamber 132 is positioned above the filtering and circulating chamber 130, the flow of water between the water storage chamber 132 and the lower filtering and circulating chamber 130 is gravity induced.

In the illustrated exemplary embodiment, the valve 180 includes a top portion 184 that extends into the interior of the water storage chamber 132 and comprises a top-portion valve body 185. The valve 180 further includes a lower portion 186 that extends downward from the exterior of the water storage chamber 132 and comprises a lower-portion valve body 187. In general, the valve 180 is configured to prevent water passage when the water level in the water filtering and circulating chamber 130 is at or above a desired level, but is configured to allow water passage when the water level in the chamber 130 falls below the desired level. In the illustrated embodiment, the desired water level is set so that the water level in the water tray 120 does not overflow from the tray (e.g., the water level in the water tray 120 is 0.5-20 cm below the rim of the tray).

In the illustrated embodiment, the lower portion 186 of the valve 180 includes a float 188 that is coupled to a float stem 190, which is coupled to a conical plug 192 (seen in FIG. 15). The float 188 can be formed of any material that floats in water. In the illustrated embodiment, the float is a puck-shaped foam float that is enclosed in a water-resistant cover 194 from which the float stem 190 extends. Further, in the illustrated embodiment, the plug 192 is a conical plastic plug that is configured to be selectively insertable into valve passage 196 depending on the water level in the water filtering and circulating chamber 130. The valve passage 196 is a passage (or aperture) that extends between the top portion 184 and the lower portion 186 and allows the passage of fluid between the water storage chamber 132 and the water filtering and circulating chamber 130. The valve passage 196 is best seen in FIG. 14. In particular, and as shown in FIG. 15, when the water level in the water filtering and circulating chamber 130 is below a desired level, the float 188 is lowered so that the plug 192 is withdrawn from the valve passage 196, thereby allowing water to pass from the water storage chamber 132 into the water filtering and circulating chamber 130. Further, the plug 192 can include a collar that prevents it from being withdrawn from the lower-portion valve body 187. When the water level in the water filtering and circulating chamber 130 rises, however, the float 188 will also rise, thereby urging the plug 192 into the valve passage 196 until water flow is stopped (shown in FIG. 16). In this way, the valve 180 operates to effectively regulate and maintain the water level in the water filtering and circulating chamber 130 and the water tray 120.

The particular valve configuration shown in FIGS. 13-16 should not be construed as limiting in any way, as various other valve mechanisms can be used to selectively allow passage of water from the water storage chamber 132 to the water filtering and circulating chamber 130 in response to the water level in the water filtering and circulating chamber 130. For example, in certain embodiments, the valve that is coupled to the water storage chamber 132 can include a stem configured to extend into the interior of the water filtering and circulating chamber 130 and that includes a fluid passage aperture on the stem body at the desired depth of the water in the chamber 130. In such embodiments, the water storage chamber 132 can be otherwise airtight (e.g., the chamber can have a lid that creates an airtight seal when screwed on or have no lid at all). Thus, when the water storage chamber 132 is placed on the water filtering and circulating chamber 130, water passes through the fluid passage aperture of the valve stem until the water level exceeds the level of the fluid passage aperture. At this time, a seal is formed by the water in the water filtering and circulating chamber 130 at the fluid passage aperture preventing the passage of air through the valve into the water storage chamber 132. Consequently, the water level remains static in the both the water storage chamber 132 and the water filtering and circulating chamber 130. The valve in such embodiments can also be configured to be removable from the water storage chamber 132, thereby allowing the chamber 132 to be refilled. In certain embodiments, the valve can be further configured such that it remains closed until it is placed into position in the water filtering and circulating chamber 130. For example, the valve can include a poppet-valve mechanism. In one particular implementation, for instance, the valve stem body can include an interior stem attached to a stopper portion that is configured to close the valve until the water storage chamber 132 is lowered into position in the water filtering and circulating chamber 130. The interior stem can be sized so that when the water storage chamber 132 is in position, the bottom surface of the water filtering and circulating chamber 130 engages the interior stem and urges the interior stem along with the stopper portion inwardly into the valve body, thereby opening the valve so that fluid is allowed to flow through the valve stem and out the fluid passage aperture.

The various components of the watering system 100 can be formed from a wide variety of materials. For example, in certain embodiments, the components are formed from suitably rigid materials that are durable, resistant to easy breakage or shattering, and suitably waterproof or non-dissolving. For example, the main body central member 131, the water filtering and circulating chamber 130, the water storage chamber 132, and/or the water tray 120 can be manufactured from a hard polymer (e.g., plastic, polyethylene, polypropylene, acrylonitrile butadiene styrene (“ABS”), or other such polymers). In such cases, these components can be manufactured using one or more of a variety of techniques (e.g., injection molding). In other embodiments, other suitable materials are used to manufacture one or more of main body central member 131, the water filtering and circulating chamber 130, the water storage chamber 132, and/or the water tray 120 (e.g., rubber, metal, chrome, and the like).

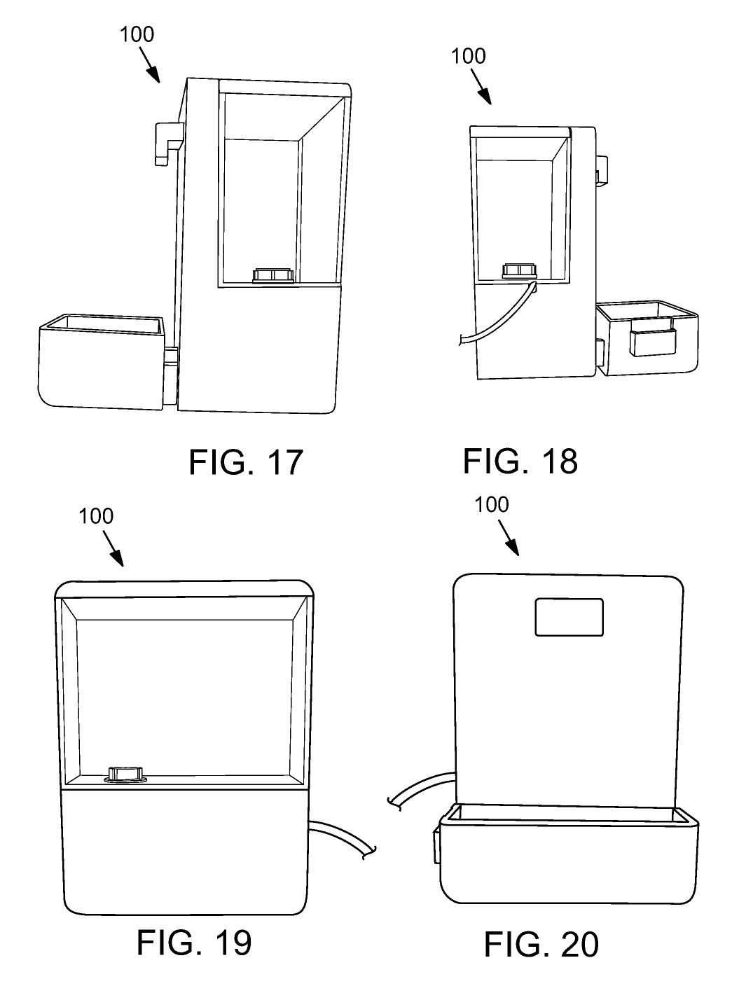

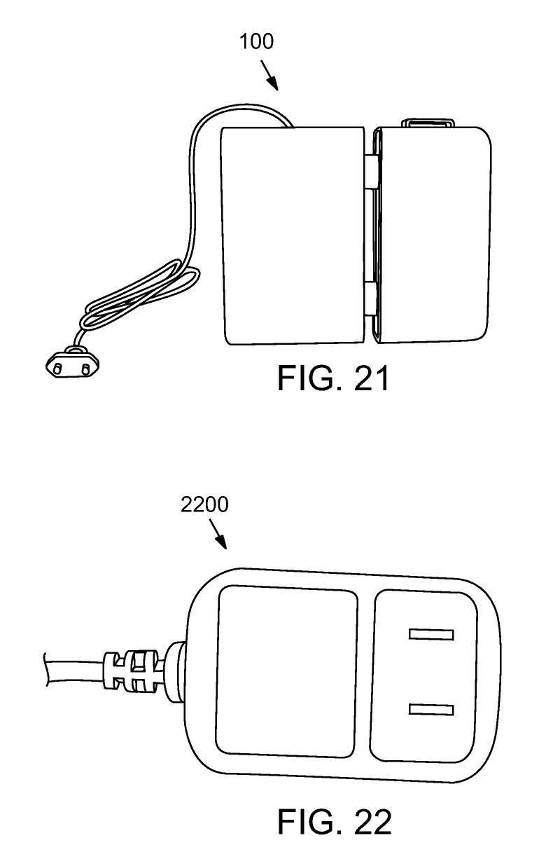

FIGS. 17-21 show additional views of the exemplary watering system 100. In particular, FIG. 17 is a right side view of the watering system 100, FIG. 18 is a left side view of the watering system 100, FIG. 19 is back side view of the watering system 100, FIG. 20 is a front side view of the watering system 100, and FIG. 21 is bottom view of the watering system 100.

The size of the watering system 100 can vary from implementation to implementation and can depend, for example, on the animal for which it is designed. In certain non-limiting embodiments, for example, the watering system 100 has an overall height of between 15 and 35 cm (e.g., at or about 21 cm), with the water tray 120 having a height of between 2 and 8 cm (e.g., at or about 5 cm). In certain embodiments, the height of the filtering and circulating chamber 130 is between 4 and 14 cm (e.g., at or about 8 cm), whereas the height of the water storage chamber 132 is between 4 and 30 cm (e.g., at or about 12 cm with a 1 cm lid). Further, in certain embodiments, the watering system 100 has a length (measured from the left side edge to the right side edge of the watering system 100 (shown from left to right in FIG. 20)) of between 8 and 30 cm (e.g., at or about 16 cm), and an overall width (measured from the front side edge to the back side edge of the watering system 100 (shown from left to right in FIG. 17) of between 10 and 30 cm (e.g., at or about 19 cm). In certain embodiments, the width of the water tray 120 can be between 4 and 15 cm (e.g., at or about 8 cm), whereas the width of the main body 110 can be between 4 and 20 cm (e.g., at or about 10 cm, with the width of the main body central member 131 being at or about 2 cm and the width of the filtering and circulating chamber 130 and the water storage chamber 132 being at or about 8 cm). The width of the gap between the water tray 120 and the main body 110 can also vary and depend on the size of the cage, kennel, or crate the system is configured to be attachable to. In certain embodiments, the gap is between 0.5 and 4 cm (e.g., at or about 1 cm). The depth of the interiors of the water tray 120, the filtering and circulating chamber 130, and the water storage chamber 132 can also vary. For example, in certain embodiments, the depth of the water tray is between 2 and 8 cm (e.g., at or about 4.5 cm), the depth of the filtering and circulating chamber 130 is between 4 and 14 cm (e.g., at or about 7.5 cm), and the depth of the water storage chamber 132 is between 4 and 30 cm (e.g., at or about 11.5 cm). The size of the filter 144 can also vary. For example, in certain embodiments, the filter has a width of between 4 and 14 cm (e.g., at or about 7.25 cm) and a height of between 4 and 14 cm (e.g., at or about 6.75 cm).

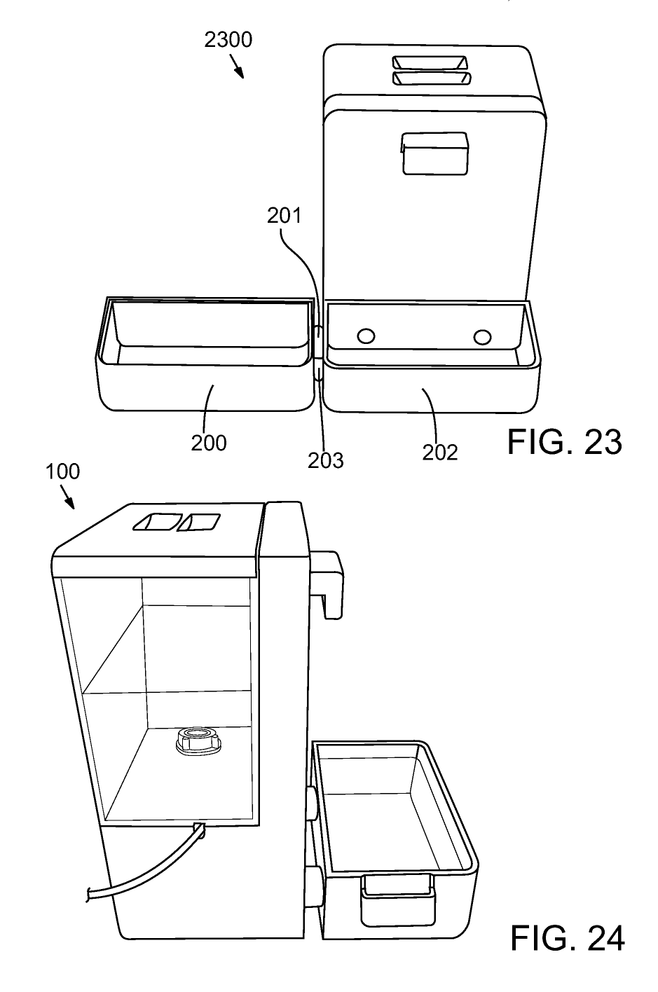

FIG. 23 is a perspective view of another embodiment 2300 of a watering system similar to that of system 100 that includes a food tray 200 coupled to a water tray 202. In particular, the food tray 200 includes a protrusion 201 (e.g., a tongue or L-shaped member) that is configured to be insertable into the interior of the protrusion 203 of the water tray 202, thereby securing the food tray 200 to the water tray 202. The food tray 200 can be configured so that it is removable from the water tray 202 by lifting the food tray 200, thereby disengages the frictional fit between the protrusion 201 of the food tray and the protrusion 203 of the water tray.

Having described and illustrated the principles of my innovations in the detailed description and accompanying drawings, it will be recognized that the various embodiments can be modified in arrangement and detail without departing from such principles. For example, the pump of the water container can be selectively activated based on the proximate presence of an animal. In particular embodiments, for instance, the pump can be configured to receive an activation signal from an RF ID sensor that detects when an animal wearing a collar with an authorized RF ID tag (e.g., an active RF ID transmitter or a passive RD ID tag) is in proximity of the watering system.

In view of the many possible embodiments to which the principles of the disclosed technology may be applied, it should be recognized that the illustrated embodiments are only preferred examples of the disclosed technology and should not be taken as limiting the scope of the invention. Instead, the invention is defined by the following claims and their equivalents.

What is claimed is:

1. A watering system for attachment to an animal cage, kennel, or crate comprising:
a main body portion comprising a water storage chamber and a water filtering and circulating chamber, the water storage chamber being fluidly coupled with the water filtering and circulating chamber via a valve between the water storage chamber and the water filtering and circulating chamber;
a water tray, the water tray being removably attachable to the main body portion, the main body portion and the water tray being fluidly coupled to one another when the water tray is attached to the main body portion;
a water filtration system in the water filtering and circulating chamber; and
a water circulating system, wherein the water circulating system is configured to automatically deactivate when the water in the watering system is insufficient to circulate using the water circulating system.

2. The watering system of claim 1, wherein the valve is configured to selectively allow passage of water from the water storage chamber into the water filtering and circulating chamber when the water level in the water filtering and circulating chamber is below a threshold depth.

3. The watering system of claim 2, wherein the valve comprises a float and a valve plug, the valve plug coupled to the float and configured to plug a valve passage when the float is at or above the threshold depth.

4. The watering system of claim 1, wherein the water tray and the main body are fluidly coupled by at least two fluid conduits when the water tray is attached to the main body portion.

5. The watering system of claim 1, wherein the water filtration system comprises ion-exchange resin elements.

6. The watering system of claim 1, wherein the water circulating system comprises:
a controllable pump;
one or more sensors configured to detect a speed of the controllable pump; and
a controller configured to receive speed data from the one or more sensors and to selectively deactivate the controllable pump based at least in part on the speed data.

7. The watering system of claim 6, wherein the controllable pump is oriented such that an input port faces downward toward a bottom of the watering system.

8. The watering system of claim 6, wherein the controllable pump comprises a DC pump.

9. The watering system of claim 1, wherein the water circulating system is configured to selectively activate upon receipt of a radio frequency identification signal.

10. A watering system configured for attachment to an animal cage, kennel, or crate comprising a water circulating system, the water circulating system being configured to automatically deactivate when the water in the watering system is insufficient to circulate using the water circulating system.

11. The watering system of claim 10, wherein the water circulating system comprises a DC pump.

12. The watering system of claim 10, wherein the water circulating system comprises:
a controllable pump;
one or more sensors configured to detect a speed of the controllable pump; and
a controller configured to receive speed data from the sensors and to selectively deactivate the controllable pump based at least in part on the speed data.

13. The watering system of claim 10, wherein an input port of the pump is oriented so that the input port faces downward toward a bottom of the watering system.

14. A watering system configured for attachment to an animal cage, kennel, or crate comprising a water filtration system that comprises one or more ion-exchange resin elements.

15. The watering system of claim 14, wherein the water filtration system further comprises one or more of carbon elements, a UV filter, sponge filter, or a filter comprising one or more apertures configured to filter particles having a selected diameter.

16. A watering system configured for attachment to an animal cage, kennel, or crate comprising:
a main body portion comprising a water storage chamber and a water filtering and circulating chamber, the water storage chamber being fluidly coupled with the water filtering and circulating chamber via a valve between the water storage chamber and the water filtering and circulating chamber; and
a water tray, the water tray being selectively attachable to the main body portion via two or more fluid conduits, the main body portion and the water tray being fluidly coupled to one another when the water tray is attached to the main body portion via the two or more fluid conduits.

17. The watering system of claim 16, wherein the valve is configured to selectively allow passage of water from the water storage chamber into the water filtering and circulating chamber when the water level in the water filtering and circulating chamber is below a threshold depth.

18. The watering system of claim 16, wherein the valve comprises:
a float; and
a valve plug coupled to the float and configured to plug a valve passage when the float is at or above the threshold depth.

19. The watering system of claim 16, wherein the valve is a gravity-induced valve.

20. The watering system of claim 16, wherein the water filtering and circulating chamber comprises a filter with one or more ion-exchange resin elements.
